(19) United States
(12) Patent Application Publication
(10) Pub. No.: US 2025/0281348 A1
(43) Pub. Date: Sep. 11, 2025

(54) ADULT TOY AND RELATED NETWORK AND SERVICE-BASED INTERACTION

(71) Applicant: Kiiroo B.V., Amsterdam (NL)

(72) Inventors: Antonio Lo Presti, Amsterdam (NL); Toon Timmermans, Amsterdam (NL)

(21) Appl. No.: 18/743,790

(22) Filed: Jun. 14, 2024

Related U.S. Application Data
(60) Provisional application No. 63/562,865, filed on Mar. 8, 2024.

(51) Int. Cl. A61H 19/00; A61H 23/02

(52) U.S. Cl. CPC A61H 19/34; A61H 19/44; A61H 23/02; A61H 2201/0188; A61H 2201/5012; A61H 2201/5043

(57) ABSTRACT

A device used in live performances is networked to provide sensory stimuli in response to customer and/or viewer feedback. In forms in which this device is embodied as an adult toy, and is used for live adult performances, the device can be caused to exhibit predetermined behavior (e.g., “playing” predetermined patterns of sensory stimuli) when and as certain feedback events (such as tipping thresholds) are detected. In a specific case, an adult toy (and optional accessories) can play custom light shows in tandem with playing predetermined (e.g., intense) vibration patterns as individual feedback thresholds are met. This disclosure also contemplates stand-alone designs devices, accessories, software applications, and system and service embodiments.

### REFERENCE TO RELATED APPLICATIONS

This patent application claims the benefit of U.S. Provisional Patent Application No. 63/562,865, filed Mar. 8, 2024, for “Adult toy and related network and service-based interaction;” each aforementioned patent application is hereby incorporated by reference.

### BACKGROUND

In recent years, network-based live adult performance services have evolved such that they now represent a significant market; service providers have looked for ways to increase dynamic interaction between performers and/or customers. The present invention addresses this need and provides further, related advantages.

### BRIEF DESCRIPTION OF THE DRAWINGS

FIG. 1A is an illustrative diagram, used to introduce operation of a device, network, live service, and related systems which represent various embodiments.

FIG. 1B is a block diagram, used to illustrate one embodiment of a network-based system, and to narrate how that system can be used to provide live services which feature feedback.

FIG. 1C is a block diagram, used to illustrate one embodiment of a performer network.

FIG. 2A is a block diagram showing one embodiment of a performer device; such a device is optionally an adult toy, and can optionally be used in the performer network of FIG. 1C.

FIG. 2B is a block diagram representing another embodiment of an adult toy.

FIG. 3A is a perspective view of still another embodiment of an adult toy, specifically, a vibrator; the vibrator has a first, bulbous end 303, which can be used for insertion and/or stimulation, and a second end 305, which mounts one or more audiovisual transducers. Differently-hatched regions 307-1 to 307-6 exemplify the use of a ring array of built-in multicolor light-emitting diodes (LEDS), as part of the one or more audiovisual transducers, to provide a time-varied light display, with different colors and/or different brightness levels.

FIG. 3B is a cross-sectional view of an example implementation of the adult toy from FIG. 3A, taken from direction of line 3-3 in FIG. 3A; this view shows the internal configuration of the multicolor LEDs within a “tail” of the device of FIG. 3A.

FIG. 3C is a cross-sectional view of an alternate implementation of the tail of the adult toy from FIG. 3A, taken once again from the perspective of line 3-3; instead of a ring-array of LEDs, a liquid crystal display (LCD) screen is used to imbue the device with sophisticated control, programming and display capabilities.

FIG. 4A is a perspective view of one embodiment of an adult toy, specifically, a plug, which embodies principles of this disclosure.

FIG. 4B is a perspective view of another embodiment of a plug which embodies principles of this disclosure.

FIG. 5A is a perspective view of another adult toy example, specifically, a clitoral stimulator, which embodies principles of this disclosure.

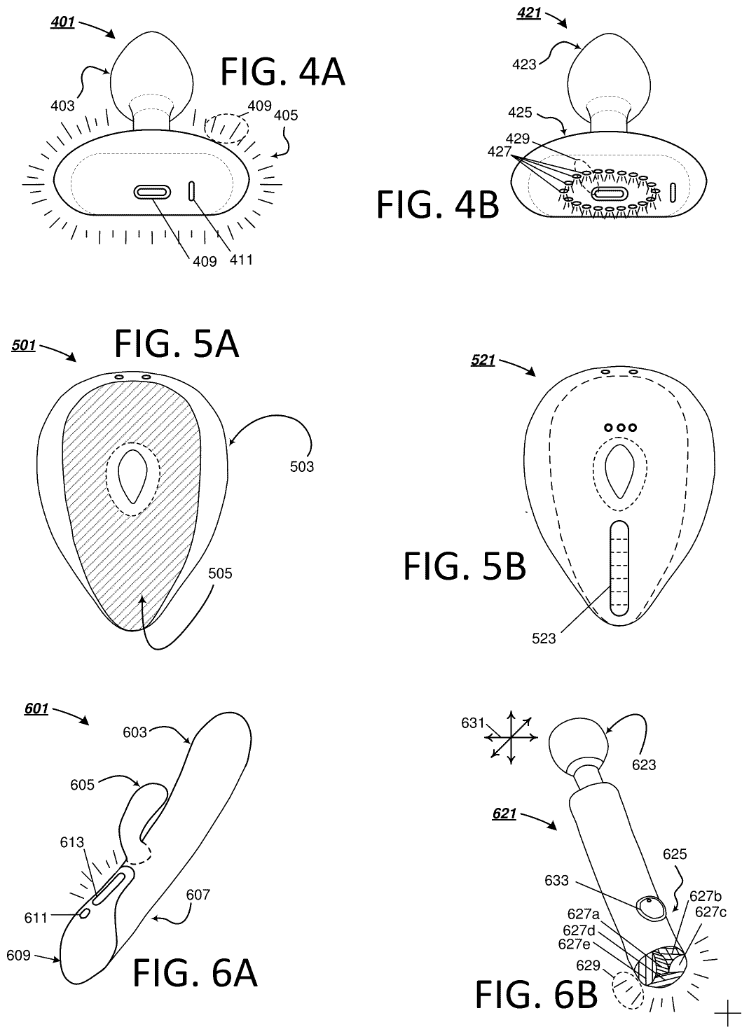

FIG. 4B is a perspective view of another embodiment of a clitoral stimulator which embodies principles of this disclosure.

FIG. 6A is a perspective view of one embodiment of a rabbit vibrator which embodies principles of this disclosure.

FIG. 6B is a perspective view of one embodiment of a wand vibrator which embodies principles of this disclosure.

FIG. 7A is a perspective view of one embodiment of an accessory, for example, a standing accent light, display or audio speaker, which embodies principles of this disclosure.

FIG. 7B is a perspective view of one embodiment of an accessory, specifically, a headdress (i.e., a crown), which embodies principles of this disclosure.

FIG. 7C is a perspective view of one embodiment of a tiara which embodies principles of this disclosure.

FIG. 7D is a perspective view of one embodiment of a cowboy hat which embodies principles of this disclosure.

FIG. 7E is a perspective view of one embodiment of an accessory, specifically, a clothing item (e.g., a ballerina skirt), which embodies principles of this disclosure.

FIG. 7F is a perspective view of another example clothing item, specifically, a brazier, which can be used as a performer device/accessory.

FIG. 7G is a perspective view of one embodiment of light string accessory which embodies principles of this disclosure.

FIG. 8 is an illustrative, plan view of an individual during a live show; FIG. 8 depicts, in part, how some of the accessories exemplified by FIGS. 7A-7F can be arranged and used so as to enhance the live show.

FIG. 9A is a block diagram showing software flow for a user application (“app.”); in one embodiment, such an app. can be downloaded to and installed on a user computing device, such as a smart phone, laptop computer, desktop computer, performer device, or some other “smart” user/performer device or system.

FIG. 9B is a block diagram showing software/instructional logic flow for one embodiment for a performer device, such as an adult toy, which embodies principles from this disclosure.

FIG. 9C is a block diagram showing components of an optional customer/viewer software app.

FIG. 10A is a screen shot representing use of an example user interface (“UI”) to define events, triggers (e.g., thresholds) and associated patterns; the depicted events correspond to tip (i.e., gratuity) thresholds associated with a live adult performance, but the depicted embodiments are not so-limited.

FIG. 10B is another screen shot showing use of a UI to define events, triggers and patterns.

FIG. 10C is another screen shot representing exemplary use of a UI. Shading in FIG. 10C (and in some of the other FIGS. referenced herein) should be understood to be a proxy for intensity variation, hue variation or color variation (e.g., each shade in the depicted wheel representing a different color).

FIGS. 11A-11F correspond generally to an end of a vibrator, more specifically, the tail of the embodiment from FIGS. 3A-3B, but with hatching overlays added, to narrate an example light show.

FIG. 11A shows presentation of a first color, represented by hatch lines which run from upper left to lower right; the first color is displayed at a first time, using only a first subset or portion of the LED display.

FIG. 11B shows presentation of a second color, represented by intersecting vertical and horizontal hatch lines, using a second portion of the LED display; the second color in this example is displayed at a second time, as part of a sequence.

FIG. 11C shows presentation of a third color (represented by purely vertical hatch lines), using a third portion of the LED display; the second color is displayed at a third time, as part of a third portion of the pattern or sequence.

FIG. 11D shows presentation of three simultaneous colors at a fourth point in time, respectively, at fifth, sixth and seventh portions of the LED display area; one of these colors, represented by numeral 1143, is the third color from FIG. 11C, while fourth and fifth colors are presented at other portions of the LED display.

FIG. 11E shows the entire ring-LED display as lit with the second color (i.e., from FIG. 11B), at a fifth point in time.

FIG. 11F shows half of the display, illuminated once again with the second color, at a sixth point in time.

FIG. 12A is a screen shot showing an example UI.

FIG. 12B is a screen shot showing another example UI.

The subject matter defined by the enumerated claims may be better understood by referring to the following detailed description, which should be read in conjunction with the accompanying drawings. This description of one or more particular embodiments, set out below to enable one to build and use various implementations of the technology set forth by the claims, is not intended to limit the enumerated claims, but to exemplify their application. Without limiting the foregoing, this disclosure provides several different examples of performer devices (e.g., adult toys) that can be used in association with a live service, with feedback patterns being generated upon dynamic event satisfaction associated with the live service; for example, a device can be designed or configured to exhibit certain sound, audio, visual, vibratory or other effects in response to tipping thresholds being met. This disclosure contemplates devices, networks, software applications, services and other components, used either together or in isolation. While specific examples are presented, the principles described herein may also be applied to other methods, devices, services and systems as well.

### DETAILED DESCRIPTION

This disclosure provides techniques for addressing the need referenced above.

One embodiment provides methods for providing a live performance, as well as related systems, devices and components (e.g., such as software). A camera or other capture device captures live content from a performer. The live content can be, but is not limited to, adult content. This live content is provided as a “show” to one or more customers/viewers. A central or networked component monitors dynamic feedback from the one or more customer/viewers, to detect occurrence of one or more events. Each event can represent a predetermined (and, in some cases, customized) feedback condition from the one or more customers/viewers, measured against one or more thresholds for dynamic satisfaction during the show. When satisfaction of these one or more thresholds is established, the component identifies occurrence of the corresponding event and triggers an associated response action, typically a pattern of sensory stimuli, on a device of the performer (“performer device”). The performer device, in some cases, an adult toy, is thereby controlled to present some type of dynamic sensory stimuli, which is either discerned by the customer/viewer as part of the show or otherwise is discerned by the performer, who can then react to that feedback as part of the content.

Note that this disclosure contemplates a wide range of different components that can be built, used or sold in standalone form, for optional use together. For example, one embodiment of the techniques provided by this disclosure is a device, in some cases, as an adult toy. An example adult toy which will be presented below is a vibrator adapted to transduce light and vibration as a response triggered by detected occurrence of a programmed event. It is contemplated that such a novel device may be sold in standalone form and optionally used in connection with the network, software, live performance and other components discussed herein. In some but not all embodiments, the pattern, frequency, intensity, type of triggered activities, durations, colors, and various other parameters can each be programmed and/or customized by a human user (e.g., performer), as appropriate to the specific device, as can the associated event thresholds. In other embodiments, the techniques expressed herein are expressed in the form of a live content presentation service, for example, hosted by a web site, which detects events and provides event-triggered signals back to performers or content providers, as performance feedback. In yet other embodiments, instructional code (e.g., software) can be installed on a digital device or system to enable customization of events, associated thresholds, and event responses. Other implementations and uses cases will be made clear from the discussion which follows.

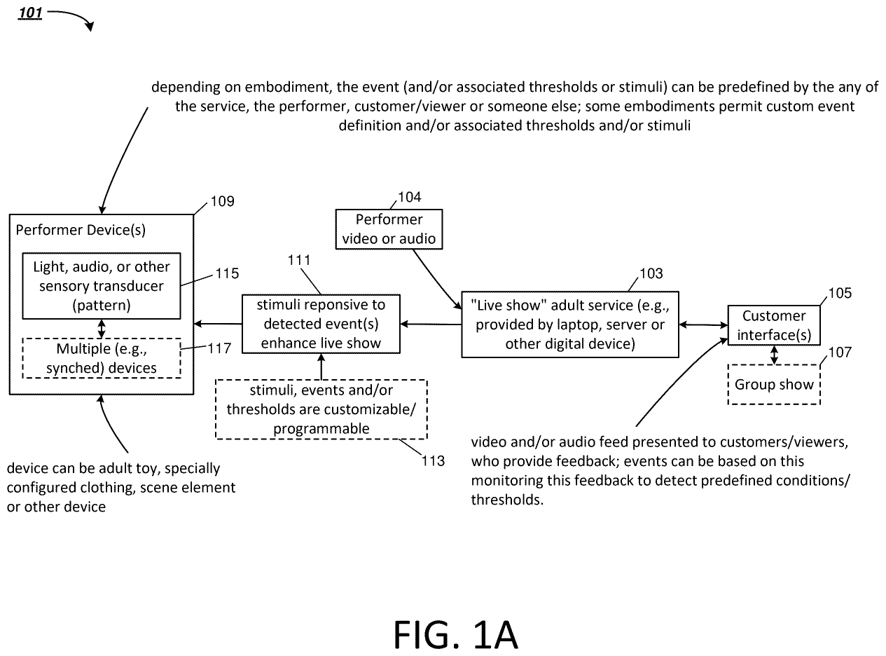

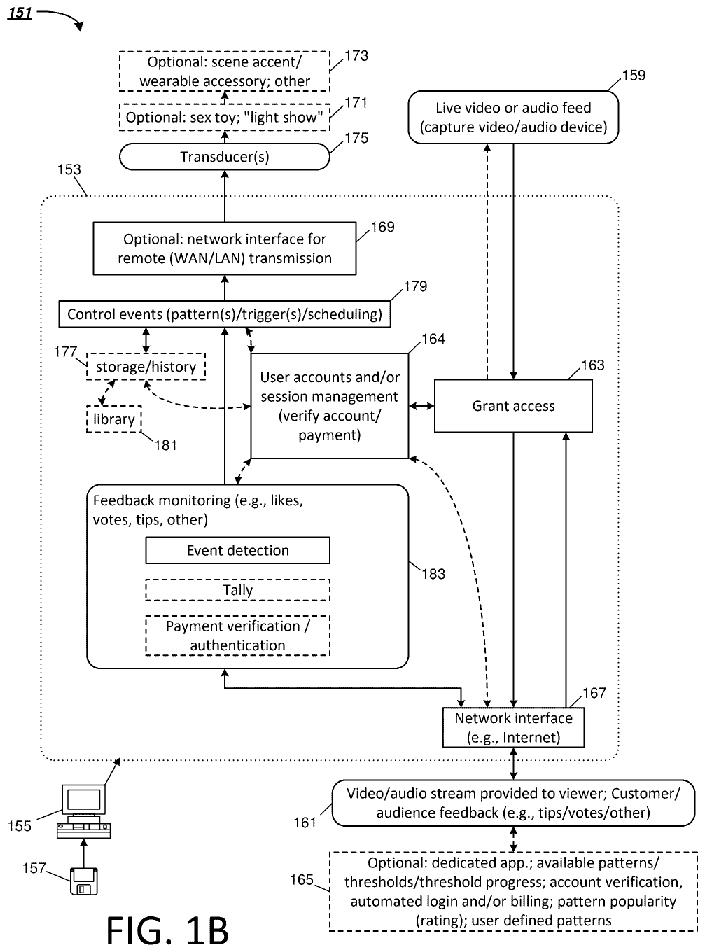

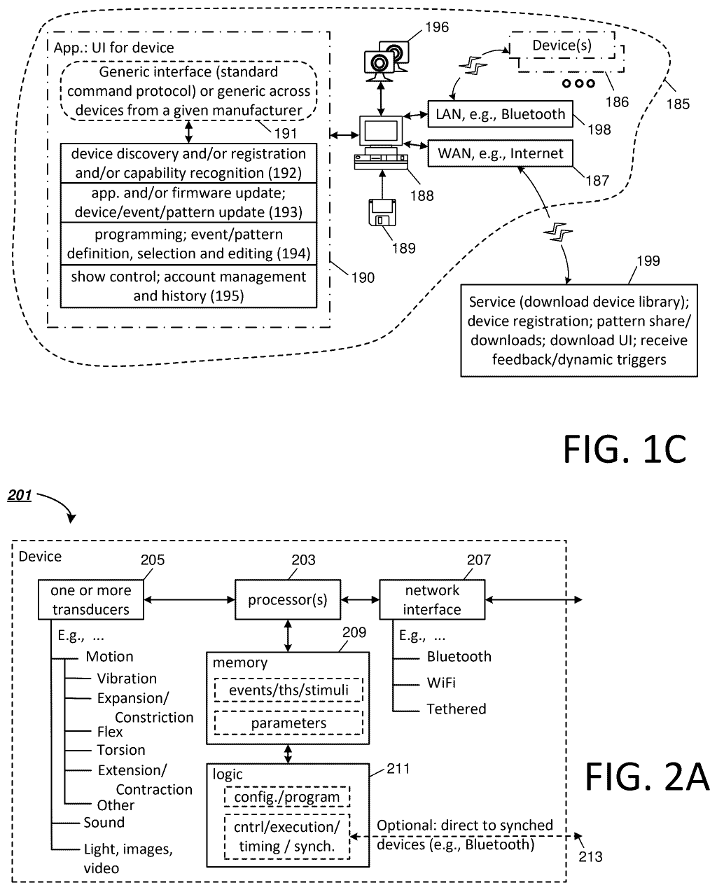

At this juncture, a further, illustrative introductory example would be helpful. FIG. 1A is referenced to assist with this purpose. FIG. 1A generally shows components 101 associated with provision of a live show adult service. A central or networked component 103 (e.g., such as a laptop, server or other digital system) hosts/provides a live show adult service on a subscription or pay-per-session basis. Performer video or audio 104 is captured from the performer, by a capture device, and is streamed to one or more customers/viewers. A customer interface 105, for example, on a digital device such as a computer or other smart device belonging to the particular customer/viewer, displays the live show to the that customer/viewer. As indicated by numeral 107, in some but not all cases, the live show can be broadcast to a group (i.e., there can be more than one customer/viewer and associated viewing device). As indicated by text in the FIG., customers/viewers enjoying the show can dynamically express their appreciation as feedback, for example, in the form of performer tips (gratuities). Note that this form of dynamic feedback (i.e., tipping) is not required for all embodiments, e.g., the feedback can be in the form of “likes,” “votes” or in some other form. The central or networked component 103 monitors this feedback against one or more thresholds and detects occurrence of events as corresponding threshold sets are met; the central or networked component then sends stimuli to a performer device 109 and/or sends a trigger signal, or command of some sort, per function block 111, to cause the performer device 109 to play/transduce that stimuli. Many types of events and associated stimuli can be driven in this way, and different performer devices can have different thresholds associated with the same event type; as a non-limiting example, a first stimuli (e.g., light or vibration pattern) can be driven on the performer device if a first tipping threshold is met by a customer/viewer (e.g., by any single viewer) and a second, potentially much longer or more intense stimuli (e.g., light and/or vibration pattern) can be driven if a second, larger, collective tipping threshold is met. Clearly, there are many possible patterns and associated events that can be implemented using these techniques, as suits the preferences of the service, performer, customer/viewer, etc. Some embodiments “play” stimuli other than vibration or light, for example, they can play sounds, music or audio clips, present images or video, and so forth.

Note that while a live commercial service is the subject of this example, some embodiments are adapted to private, non-commercial use, e.g., for use by a couple, a private group of individuals, or otherwise. Also, note once again that the techniques presented by this disclosure can be in different forms, such as in the form of a standalone device, such as an adult toy, an accessory (several examples will be given below), a computer, a downloadable software application, a browser-based service, a hosted web site or service, a commercial service, and on-line sharing or pairing service, and so forth.

FIG. 1A introduces some further options as well. First, as noted by box 113 in the FIG., in one embodiment, the stimuli which is driven on the performer device is programmable and/or customizable, as are the event definitions and associated thresholds; this is typically performed in advance, in an offline process, such that it is automatically executed by circuitry during a live show. In yet another implementation, this programming/customization can be performed by the service, with a common set of events (and associated stimuli) being made available to multiple performers. In still another embodiment, customers/viewers define their own custom stimuli, and submit those for execution (e.g., subject to appropriate pricing and payment as a detected event); as a non-limiting example, an adult service can, using described techniques, permit customers/viewers to define their own stimuli, with pricing (i.e., minimum tips) automatically calculated based on defined parameters such as pattern length, intensity, and so forth. As alluded to earlier, a central or networked component could store or provide a “library” of stimuli (e.g., light and/or vibrational patterns), indexed based on ratings from performers or customers/viewers, with the result that a set of highly-rated, stock stimuli patterns would be developed over time, and then be used by multiple performers and/or private parties. This further enhances the potential excitement provided by the live show. Second, as referenced by box 115, and depending on supported characteristics of the device 109, the stimuli can include any type of perceptible stimulus—in one case, the stimulus can be light (e.g., a light pattern), but in other cases, the stimulus can be in the form of motion (e.g., vibrating, flexing, contracting, thrusting or other motion), or in video, images or audio. As denoted by box 117, there can also optionally be multiple transducers or multiple (synched) performer devices, for example, an adult toy with a primary transducer that is under the control of a user/performer, while a secondary (e.g., different) audio, motion, or visual transducer is provided as part of the device to respond to dynamically-controlled triggers. In some embodiments, the device 109 need not be an adult toy at all, but rather, can be some type of accessory such as a piece of clothing or a prop (e.g., with an LED that transduces an electric signal to light); as implied, contemplated use-cases feature multiple performer devices in some cases jointly responding to events/patterns in synchronicity, and in some cases driven by respective patterns. Further examples of each of these things will be provided below.

FIG. 1B is a block diagram used to illustrate an embodiment 151 of a system and associated method for providing a live show. A central or networked component 153 of the system can be implemented in the form of one or more computers (e.g., servers, computers or other devices), typically each having instructional logic (e.g., software), circuitry, such as one or more processors, supporting memory, and other circuits. As a non-limiting example of this, functions depicted in box 153 can be implemented on one or more servers of an entity seeking to host live shows on a service bureau basis. As also expressly contemplated by a computer icon 155 and floppy disk icon 157 appearing at the bottom of the FIG., the depicted functions in one embodiment can instead or in addition be provided solely in the form of instructions stored on a physical storage medium or media of some sort (e.g., one or more disks, jump drives, physical tangible electronic memory, DVD, and so forth), whether or not currently attached to or installed on a computer, where the nature of those instructions are such that when a device is turned on, those instructions will cause (e.g., script execution steps) of the device so as to operate to perform some or all of the processing or operations seen in the FIG.

As part of a live show, the central or networked component 153 will supply a live video or audio feed from a capture source 159 to one or more customers/viewers, as is represented in the form of a box 161 at the lower-right-hand side of the FIG. Note that in some embodiments, the capture source 159 is an integral part of the central or networked component (and/or they are together part of a common local area network (“LAN”)) while, in other embodiments, the capture source is at a remote location on the Internet, such as at a performer's site. In this latter case, the performer's system connects to the service (e.g., logs in) and provides audio or video for live streaming, and the central component 153 performs access authorization and control both of the performer and of customers, as represented by box 163. For example, this function can be rooted in a user account and/or session management system 164 used to restrict live audio or video access to authenticated subscribers or to individuals who pay to view the performance. In some embodiments, these features can be hosted directly by the performer (e.g., the performer's computer acts as a server, and the performer's computer controls performance access and performs various other of the functions described herein). Also in some embodiments, access control can at least partially be performed using a dedicated customer/viewer app. This app. can optionally be configured to require establishment of an account, contain appropriate display drivers for viewing, and to provide an interface for tipping and/or other forms of feedback (to be discussed below). The depicted central or networked component 153 also shows two network interfaces 167 and 169, which respectively interface the service with customers/viewers and with one or more performers. The optional performer side interface 169, if the performer is part of a separate network, communicates indirectly through that separate network with performer devices 171 and/or accessories 173. In other embodiments, the performer side interface can communicated directly with “Internet-ready” performer devices 171 and accessories 173. Irrespective of specific communication methodology, the performer side of the connection features at least one transducer 175, which converts some type of control signal to motion, light, sound, or some other type of sensory stimuli. In some cases, interface 167 is a wide area network (“WAN”) interface, which connects the central component to the Internet, and interface 169 can be either a LAN interface or a WAN interface, depending on configuration. As is known, these various networks can feature components and/or devices connected by cable (i.e., hardwired together) or via any other type of communication system, for example, wi-fi, Bluetooth, cellular (e.g., 5th generation, or “5G”) or, indeed, any other type of communication protocol, depending on embodiment.

The central or networked component 153 also in this embodiment features one or more code modules, circuitry or other automated electronic mechanisms for monitoring feedback, detecting event conditions, and responsively triggering sensory stimuli on performer devices, and for also handling payment (e.g., in the case of tipping/gratuities); once again, these things can be embodied solely as circuitry, instructional logic on one or more computer-readable media, or some combination of these things. As introduced previously, there is some type of storage 177 which stores predetermined (e.g., preprogrammed) events and associated sensory stimuli triggers that will be used to cause transducers 175, once an event has been detected, to cause performer devices to “play” the sensory stimuli, per numeral 179. In addition, as alluded-to previously, in some embodiments, stimuli, events, and associated thresholds can optionally be customized or generated in a manner that is personal to each performer; in other embodiments, these things can be globally defined, for example, specified by a streaming service hosting entity across multiple performers. As noted, one contemplated implementation permits a service to tally customer/viewer/performer rankings on the various events and associated stimuli (e.g., stimuli patterns, such as a light show, vibrator pattern, or other transducer sequence, launched in connection with an event) and permit sharing/publication, i.e., such that custom patterns can be created and shared as a function of ranking/popularity, e.g., using a library and/or sharing function 181. In this manner, for example, the system can provide for substantial live show enhancement by publishing popular patterns and thereby maximizing use of the feedback system, further enhancing show appeal; for example, if customers/viewers and/or performers find a specific vibrator vibration and light show sequence particularly enhances the show, then the service through its rankings and sharing service can facilitate use of that event to enhance show appeal. The central or networked component 153, as noted, implements a feedback monitoring function 183 which, for example, can authenticate tips (gratuities) and/or receive payment, tally votes, likes and other forms of feedback, and responsively interact with the control, triggering and/or scheduling function, to recognize each event's occurrence.

It is again noted that a tipping service and commercial adult service is not contemplated for all embodiments, e.g., the techniques disclosed herein can be applied to a private network and used between a single performer and a single viewer, without regard to whether audio/video is captured as part of the same network or as part of a commercial or preplanned show. Also, it is possible to have a service that provides just feedback (and events) to its clients, i.e., the audio or video streaming is performed separately (e.g., directly between performer and the viewer/customer), with the live content streaming being optional to this service.

FIG. 1C is a block diagram that illustrates an example performer network 185. It will be recalled that a performer and his or her devices can be local to, or remote from, a central or networked component which performs streaming and control functions. FIG. 1C illustrates the performer perspective of such an embodiment, that is, where the performer has at least one processor, one or more smart devices 186 that will present stimuli (e.g., play stimuli patterns) responsive to detected events, and means for communicating with a network (e.g., WAN interface 187). It is noted that FIG. 1C shows a computer icon 188, but this depiction is meant to be general in nature for any processor-based digital devices (including, without limitation, a smart phone), and this depiction also encompasses, for instance, a smart device (such as an adult toy) having one or more processors and integrated control functions. Once again, the one or more processors, whatever form they are embodied in, can be controlled in accordance with instructions stored on one or more physical storage media, as represented by floppy disk icon 189. FIG. 1C denotes (via dashed-line/option box 190) that these instructions can be provided in the form of a downloadable app. which is, for example, installed on a desktop, laptop, smart phone, toy, or other device from an app. store on a latent basis. Also, advantageously, the instructions can effectuate a generic interface, for example, providing for a common command and communication protocol 191 for communicated with devices (e.g., adult toys and/or accessories) from different manufacturers, each having different, potentially unknown capabilities. The instructions (e.g., app.) can optionally include modules or functions which provide for device discovery and/or registration and/or capability recognition (192), app. and/or firmware update, and device/event/pattern database update (193), programming and custom event/stimuli definition, and associated selection and editing (194), show control (e.g., start, stop, storage, and so forth) and related account management and history (195). Other functions can also be prescribed by the instructions. While configured as a downloadable app. in some cases, in other cases, the depicted functions are implemented as firmware resident on a device, for example, defined as part of the operating system of a performer device (e.g., adult toy).

As noted, in some embodiments, the software optionally provides for show control functions and, to this end, a performer's network typically includes at least one capture device (and potentially many capture devices), which are proxied in the FIG. by webcam icons 196. These icons are meant to encompass audio and/or video streaming whether or not performed by a webcam, and conversely, while these elements are seen as directly connected (in a typical case) to a performer's computer or other digital device, in other embodiments, these elements can be connected wirelessly and/or can be connected directly with a remote service (e.g., on an “Internet-ready” basis). The performer's network 185 typically includes a WAN connection (e.g., interface), for communicating with a remote service and/or customers/viewers, and for receiving feedback from customers, or triggers, or stimulus pattern control information that will be used to control transducers which are resident on one or more performer devices 186. To this end, in this embodiment, the performer network also is seen to include a LAN interface 198, e.g., the performer devices 186, upon discovery, can be configured for Bluetooth or similar communication with the performer's computer 188 (or, once again, as “Internet-ready” devices).

Embodiments which root the performer network 185 in a computer, smart phone or other sophisticated digital device, with functions invoked by a dedicated software application, provide a number of advantages. For example, as implied by function flock 199, the performer can more readily interact directly with a service to perform registration, event/stimuli customization and downloads, firmware updates, show control, tipping verification and associated accounting, and other features, as pertinent to the embodiment, all using a conventional UI format.

Prior to proceeding further, it would be helpful to discuss the meaning of several specific terms used herein. Firstly, it should be understood that contemplated embodiments can include “hardware logic,” “circuits” or “circuitry” (each meaning one or more electronic circuits). Generally speaking, and unless otherwise specified, these terms can include analog and/or digital circuitry, and can be, in nature, special purpose or general purpose. For example, as used herein, the term “circuitry” for performing a particular function can include one or more electronic circuits that are either “hard-wired” or are configurable circuits to perform the stated function (i.e., in some cases without assistance of instructional logic); for example, “circuitry” can include a microcontroller, microprocessor, FPGA or other form of processor which is general in design but which runs software or firmware (e.g., instructional logic). Such software or firmware causes or configures general circuitry (e.g., configures or directs a circuit processor) to perform the particular function. Note that as these statements imply, “circuits” and “circuitry” for one purpose are not necessarily mutually-exclusive to “circuits” or “circuitry” for another purpose, e.g., circuitry configured to perform one function can be shared and potentially overlap significantly or entirely with “circuitry” to perform another function (indeed, such is often the case where the “circuitry” includes a processor); this is to say, “circuitry to perform (function X)” and “circuitry to perform (function Y)” can encompass exactly the same circuitry or respective circuits, depending on implementation. Related to these points, the term “logic” can encompass hardware logic, instructional logic, or both, unless otherwise specifically indicated. Instructional logic can be code written or designed in a manner that has certain structure (architectural features) such that, when the code is ultimately executed, the code causes the one or more general purpose machines (e.g., a processor, computer or other machine) each to behave as a special purpose machine, having structure that performs, upon occurrence of defined events, described tasks with respect to processing operands, or else take specific actions or produce specific outputs. Generally speaking, circuits and/or processes described herein can, in some embodiments, be implemented as instructional logic (e.g., as instructions stored on non-transitory machine-readable media or other software logic), as hardware logic, or as any combination or permutation of these things, depending on embodiment or specific design. In connection with various embodiments herein, the term “device” is used to refer to an electronic product with circuitry and possibly, but not necessarily, resident software or firmware; examples of a device include, without limitation, an end consumer product, a computer, a smart phone, an integrated circuit, a die, an electronic board, and/or other manifestations, including without limitation, an adult toy. “Non-transitory” or “physical” to the extent used herein, refers to any tangible (i.e., physical structure) medium or mediums, irrespective of the type of technology used to express data on that medium and irrespective of the format of data storage; for example, in one case, a particular expression can be optically stored on physical media, and in another case, the particular expression can be magnetically stored on physical media, and different machine or human languages for this expression can also be used. Thus, instructions or logic can take form as metadata that when called is effective to invoke a certain action, as Java code or web scripting, as code written in a specific programming language (e.g., as C++ code), as a processor-specific instruction set, or in some other form. Depending on design, the instructions can also be executed by the same processor, different processors or processor cores, FPGAs or other configurable circuits, for example, being adapted for execution by a single computer in some cases, and in other cases, being adapted for execution on a distributed basis, e.g., using one or more servers, web clients, or application-specific devices, not necessarily all operating at the same time. Thus, when applied to storage and/or computer-readable and/or machine-readable subject matter, the term “non-transitory” indicates that data and/or instructions can be stored on such a physical structure storage medium using optical, magnetic, electronic, resistive and/or other storage formats/technologies, i.e., where some type of physical device, including without limitation, random access memory, hard disk memory, optical memory, a floppy disk, a compact disk (“CD”), a solid state drive (“SSD”), server storage, volatile memory, and/or nonvolatile memory, i.e., a physical thing, is used as the storage medium, and such can potentially be downloaded to, and installed or made resident, on another medium or machine. Each such medium and/or device can be in standalone form (e.g., a program disk or solid state device) or embodied as part of a larger mechanism, for example, resident memory that is part of an electronic device such as a smart phone, computer, digital television, portable device, toy, chip-card, dongle, server, printer, etc., or embodied as one or more such devices. The term “integrated circuit” (or “IC”) typically refers to a structure having at least one die, packaged or otherwise, and, as implied, a single IC and/or die can also be a type of electronic device. “Transducer” as used herein refers to a device that converts a signal from one media for expression to another, and is not limited to a device that causes physical motion; as examples, a light transducer can, depending on design, receive an electronic signal and produce light, a sound transducer can (depending on design) receive an electronic signal and can convert that signal to sound, and a motion transducer (depending on design) can receive an electronic signal and can convert it to some type of motion (e.g., linear, rotational, vibratory, translatory, and so forth). Generally speaking, for any given embodiment shown in the FIGS., optional features will be shown in the form of a dashed-line; however, it should be understood that the failure to depict other elements in dashed line does not indicate or imply that such components are required or essential, i.e., each FIG. shows an example of an embodiment only, and other embodiments/implementations are contemplated which mix and match the various features shown below, while omitting others, even where features are not expressly labeled as “optional.” The meaning of other terms used herein should be clear based on context. Note that, to the extent that any document is incorporated herein by reference, the definitions of this document should be understood to predominate over any inconsistent definitions provided by such incorporated-by-reference documents. It is emphasized that the various elements discussed above or below, in any embodiment, can be used in any desired permutation or combination, in the same or in any other embodiment, with all such permutations and combinations being expressly contemplated by this disclosure. Selection and/or omission of structures for any given design or application is within the level of ordinary skill in the art, and none of the elements/structures discussed below are to be deemed “essential” for any purpose or function.

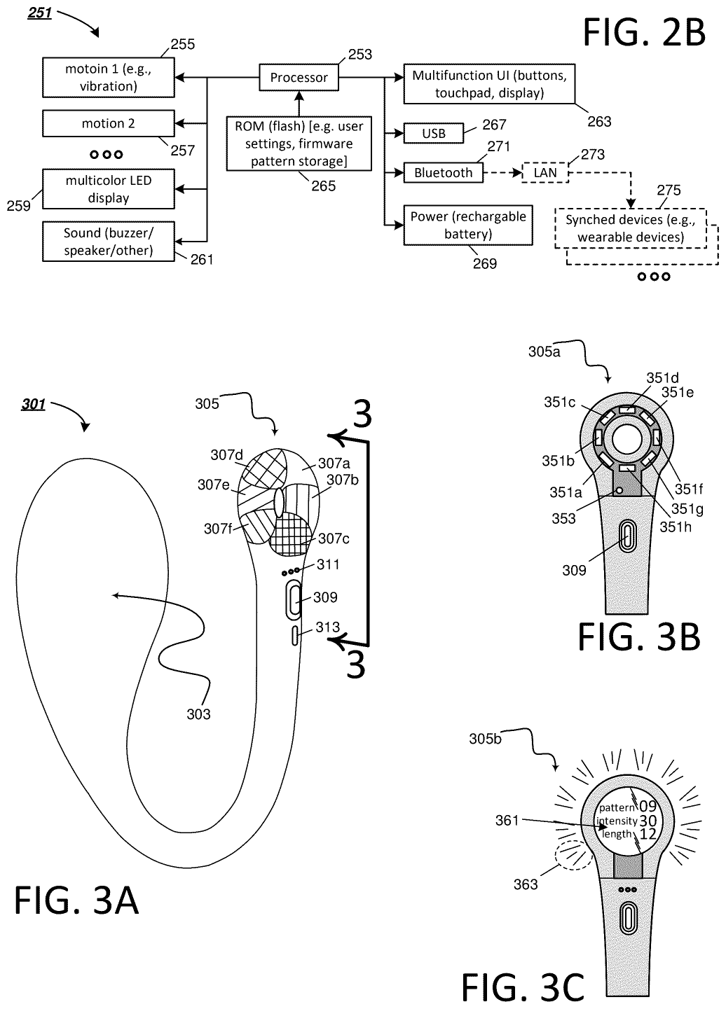

FIGS. 2A and 2B are used to generally introduce design principles for one embodiment of a performer device; such a device can be made for commercial or non-commercial use, and the use of such a device to assist with or facilitate a live show is optional.

As seen in FIG. 2A, the depicted device 201 has at least one processor 203, one or more transducers 205, memory 207 (for stimuli definition and parameter storage), a network interface 209, and logic 211 for device control, stimuli pattern execution, timing and synchronization (as appropriate) and control. As denoted at the left side of the FIG., the one or more transducers 205 can vary depending on embodiment, e.g., creating patterns of motion (such as, without limitation, vibration, expansion, constriction, flex, torsion, extension, contraction, or other types of motion, in one or more degrees of freedom), sound, light, images, video, or any combination of these things. As an example, in some embodiments to be described below, a device can be in the form of an adult toy such as a vibrator, where the vibrator includes one or more conventional vibration mechanisms, but whether a light transducer as well as a vibrator motor are used to play predefined stimuli patterns as a response to detected events (e.g., a tipping threshold is met); in a specific embodiment, a live adult show might feature exotic vibrator motion patterns of heightened intensity and a predefined light show, thereby enhancing a live show. Depending on device capabilities, the light show might feature time-sequenced variation in terms of brightness, hue, color or other parameters, across multiple light emitters; similarly, where an adult toy is capable of motion (for example, vibration, flexing, extension, constriction, etc.), enhanced motion patterns can also be driven in this same manner, and the same is true for other forms of stimuli, such as those listed in the FIG. The performer can synch content of the live show, on a dynamic basis, to these stimuli, as they are driven. This is to say, depending on configurations, stimuli patterns are perceived by the performer, who can then adapt the performance in view of the tip or other feedback signified by the stimuli pattern. Naturally, these examples are non-limiting. As implied, multiple transducers of any one type can also be used, depending on embodiment; for example, a vibrator can be designed with multiple transducers, a first one of which produces vibration (as is conventional) and a second one of which produces a spontaneous pattern of thrusting or other motion as an automatic result of some threshold (e.g., gratuity threshold) being met.

As represented by optional (i.e., dashed-line) functions depicted within memory block 207, some devices can be designed so as to store (i.e., directly onboard) definitions of events, thresholds, associated stimuli (e.g., patterns or sequences) and other parameters. In other embodiments, for example, featuring a relatively ‘dumb’ device, patterns need not be stored onboard and can instead be actuated responsive to a sequence of individual actuation commands, each describing a specific motion, or a motion parameter, such as frequency, offset, phase, intensity, etc. Note that it is also possible (and contemplated) that one device, e.g., a “master” device, can synch to and control one or more other performer devices (e.g., “slave” devices); as an example (which will be further discussed below), a ‘smart vibrator’ (which, for example, plays lights and/or audio patterns as a response to a detected event) can also use a LAN connection (e.g., Bluetooth connection) to drive synchronized patterns on other devices, for example, nearby lighting accents or “smart” adult devices used by other performers. Numeral 213 in FIG. 2A denotes this optional capability. It is also possible to have accessories driven directly by the central network or by a performer's computer, depending on embodiment. These options will be discussed further below. Finally, it is noted that the network interface 207, depending on embodiment, can be configured to communicate with a performer network or, in some cases, directly with a remote service (e.g., as an “Internet-ready” device) using any suitable or conventional networking protocol, including without limitation, Bluetooth, Wi-fi, cellular, via a tethered (wired) connection, or in some other form.

A narrated hypothetical example would be helpful at this juncture to understand how these various structures can be used to enhance a live show:
(a) A performer streams a live audio and/or video feed to one or more customers/viewers; this optionally involves live adult content;
(b) Predefined “events” define monitoring conditions for feedback regarding the show; as feedback arrives (e.g., tips), this information is aggregated and/or processed, if and as appropriate, to form metrics which are then compared against one or more thresholds. For example, if the metric is an aggregate tip minimum (i.e., which takes into account gratuities from multiple customers/viewers), then a cumulative running total of aggregated tips is used as the metric and compared to minimums and/or ranges. When these thresholds are met, and event is detected; this detection then invokes specific activities involving performer devices which are being used in the live show. To trigger these activities, a signal of some sort is sent to the pertinent performer device, where that signals causes perceptible stimuli to be generated. For example, on an adult toy, these signals might cause the presentation of light shows, intense, specific vibration patterns, and/or other stimuli; these stimuli are typically visible by the customers/viewers, but in some cases they can be directly discernible only by the performer, e.g., signaling the performer that a specific tipping threshold has been met; for example, an intense vibration pattern produced by a vibrator might be used to signal a specific tip, but might not be directly discernible by viewers; and
(c) The performer then optionally adapts the show in a manner that conveys appreciation and/or other acknowledgement of the event; note again that in some cases, stimuli can be generated primarily and/or only by performer devices which are accessory devices, for example, background lights, lights on clothing of the performer, and/or various props. for the live show.

FIG. 2B shows another block diagram of a performer device 251, specifically this time, an adult toy. This adult toy also includes circuitry such as one or more processors 253, as well as a first motion transducer 255, a second motion transducer 257, a multicolor LED display 259, and a sound transducer (e.g., buzzer, speaker or other device) 261; any of or all of these may be controlled by stimulus patterns which are triggered as a function of a dynamically detected event, for example, as feedback from a live show. The various motion transducers 255 and 257 can control multiple degrees of freedom, for example, vibration and thrusting, or two different vibrators, or thrusting in different dimensions, or radial expansion and thrusting, and so forth, to name a few, non-limiting examples. Note that some embodiments optionally omit one or more of the depicted transducers. In one optional embodiment, the user (e.g., the performer) has sole control over the motion transducers (e.g., using device controls, such as the depicted multifunction user interface, 263), while one or more other transducers (e.g., the multicolor LED display) are driven solely as event-triggered stimuli; optionally also, transducer control can be shared by entities and/or functions. As seen in the FIG., the adult toy can have memory (e.g., ROM) 265 for storage of firmware, settings, patterns (as appropriate to the embodiment), or for other purposes, and the device can optionally be provided with a physical interface (e.g., USB connection) 267 for charging of an internal battery 269, and optionally, for pattern download, configuration and/or other purposes. Alternatively, the device 251 can use its Bluetooth interface 271 for these same communication exchange purposes (e.g., via a LAN 273) and for optional control of synched devices 275, such as wearable clothing accessories.

Several specifically contemplated embodiments will now be discussed in still greater detail, in connection with FIGS. 3A-7F. FIG. 8 will then be used to present specific example as to how these things can be used together. As with the other FIGS. discussed herein, these examples are provided for illustration only and do not limit the inventive concepts expressed herein.

FIG. 3A shows one example of a vibrator 301 that can be used with the systems/methods introduced above. This vibrator 301 can be used by professional performers who stream live shows via web-cam or by other means and, of course, by private users, e.g., for their own aesthetics or for purposes of linked interaction between two or more individuals. The device connects, via an internal Bluetooth module, to other compatible devices and platforms (such as, without limitation, the “Live Jasmin” platform), including suitable software applications (“apps”) running on a computer, laptop or smart device. The vibrator 301 has a first, bulbous end 303 and a second end 305 (the “tail”), which contains a Bluetooth modem and antenna (not externally visible), to transmit and receive a Bluetooth signal. The end of the tail mounts a ring-shaped light source having multiple multicolor LEDs (not seen in FIG. 3A); these LEDs can be individually controlled so as to emit light at different levels, for example, at different intensities, hues, colors, frequencies, phases and so forth—the generated light is externally visible through the silicone cover material of the vibrator. The capability of emitting different types of light from different LEDs is represented by different cross-hatchings on the surface of the tail, at its end, with associated different light regions also being marked by numerals 307a to 307f in the FIG. The tail end 305 also has a power button/control button 309 and an audio speaker, the latter being overlaid by three small holes 311. Where it is desired to make the tail end of the device liquid proof or liquid resistant, the holes and/or audio speaker may be omitted. Numeral 313 denotes a power coupling for recharging the internal battery; this coupling preferably relies on an established plug/cabling protocol, for example, USB-C.

In this embodiment, the device is designed to be worn with the round part inside the female body of a wearer by insertion into the vagina, with the tail extending outside the body; this positioning facilitates transmission and receipt of Bluetooth or other wireless signals and it allows the LED ring light to be clearly visible. The device has a smooth silicone exterior surface which is over-molded around a hard plastic core containing a battery, motor, circuitry, and other functional elements. The motor in this case causes the device to vibrate so as to provide sexual stimulation/physical feedback to the wearer.

In conjunction with live show embodiments described earlier, the light function can be used to provide live visual feedback to viewers of the shows in the form of a light show as events are detected. As noted, in some embodiments, customers/viewers can pay tips (gratuities) in the form of credits, tokens, gifts, or currency to activate the device's vibration and light responses, or conversely, can vote, submit “likes,” and so forth, as pertinent to the particular use-case. In this manner, customers/viewers enjoy the performer's responses to feedback, and are assured by the lightshow that the tip (or other feedback) has been received, as a function of the device activation. As noted, the light show is also visible to the performer, who can then adjust performance based on this feedback. Through this feeling of participation, the customers/viewers are encouraged to tip larger and more frequently, and thereafter watch the performer's responses, and this motivates the performer to respond and thereby, and permits the performer to maximize the monetization. In embodiments in which an audio speaker is present, stimuli “played” on the performer device can be in the form of prerecorded audio, for example, music, a specific audio clip, audio submitted by the viewer providing the gratuity, or in some other form. For embodiments where a display screen is present, similarly, desired images and/or video can be presented. In the context of a vibrator, specific, intense motion patterns can also be “played” in response to gratuity (or other) events. Of course, it is possible to present any combination of these things as appropriate to the design/implementation.

FIG. 3B shows a cross-sectional plan view of the tail end of the device from FIG. 3A, taken along lines 3-3; in FIG. 3B, this tail end is numbered 305a. This FIG. shows the location of multiple multicolor LEDs 351a-351g, arranged in a ring pattern as described earlier; during operation, these LEDs can be controlled individually, emitting-when they are activated-light in a direction outward from (i.e., normal to) the drawing page, through the silicone exterior of the device (the silicone exterior is of a transparent or translucent material, either generally or in a “window region” overlying the LEDs). The FIG. also once again shows the power/control button 309 and a power indicator LED 353, but omits the audio speaker.

FIG. 3C shows an alternate tail end and is generally designated by reference numeral 305b; this tail end features a touchscreen display 361, which can be used for control functions as well as for purposes of parameter selection and programming directly on the device. Note that the embodiments of FIGS. 3A-3B can also be similarly used for programming, but the touchscreen display facilitates programming through its use of a relatively more intuitive user interface (UI). This embodiment still feature an LED display, for example, by having LEDs arranged to emit light either around a periphery of the touchscreen or outwardly from the device (e.g., as represented by illumination icons, such as 363), or, alternatively can rely solely on the touchscreen display to serve as the light transducer, for example, by rendering a light show or displaying images or video as a response to detected events. The optional integration of touchscreen displays in devices offers a variety of interactive features that significantly enhance the user experience.

FIG. 4A shows an example of a plug 401. Similar to the vibrator embodiment just discussed, this device 401 features a first, bulbous end 403, intended for bodily insertion and prostate stimulation, and a second, tail end or handle end 405. It is this second end that, once again, typically houses electronics, a Bluetooth modem (and antenna), and one or more lights or other types of transducers; these things are once again occluded from view in this FIG. and lie within the body of the device. The use of a motor (e.g., either for vibration or for extending/retracting of the bulbous end or for other motion) is optional in this embodiment. FIG. 4A shows that, in one embodiment, a light source can be designed so as to illuminate the entire toy (or the entire first end), for example, as denoted by radiance icons, e.g., 407; irrespective, the light source can once again feature one or more multicolor LEDs which are internal to the device 401. Once again, the device has an exterior surface formed of smooth silicon, preferably transparent or translucent, so as to facilitate presentation of a light show through the outer surface of the second end (e.g., responsive to meeting of a tipping threshold). The depicted device also has a control/power button 409 and a power coupling 411 for external connection to a power source, e.g., for recharging an internal battery (not shown).

FIG. 4B shows another example of a plug, 421, once again having a first, bulbous end 423 and a second, handle or tail end 435. In this case however, instead of illuminating the entire body (or a significant portion of the handle end) 425, the device includes many small multicolor LEDs, e.g., LED 427, once again, arranged as a ring structure. As represented by radiance icons, such as 429, these LEDs are configured in this embodiment to emit light downward, that is, away from the second, handle end, as depicted in the FIG.

Although, not shown in FIGS. 4A-4B, the depicted devices can once again optionally employ one or more audio speakers, touchscreens and or other types of transducers, as was introduced previously, i.e., these can be swapped in place of the ring LED display or be arranged relative to the device so as to contribute during a live show to the performance; this will generally be assumed in discussing the various embodiments going forward, i.e., specific, separate discussion of these elements as options will generally be omitted for purposes of brevity (the configuration of these speakers/displays can be similar to that described introduced earlier). The depicted design can once again be adapted for use by a performer and controlled responsive to feedback of a customer/viewer, for example, by playing a light show (or presenting other stimuli) responsive to a particular tip (gratuity) or other customer/viewer feedback. In embodiments which include a motor, for vibrational or other motion, these elements can similarly also be used to provide specific, predetermined stimuli responsive to a detected event (e.g., satisfaction of a tipping threshold).

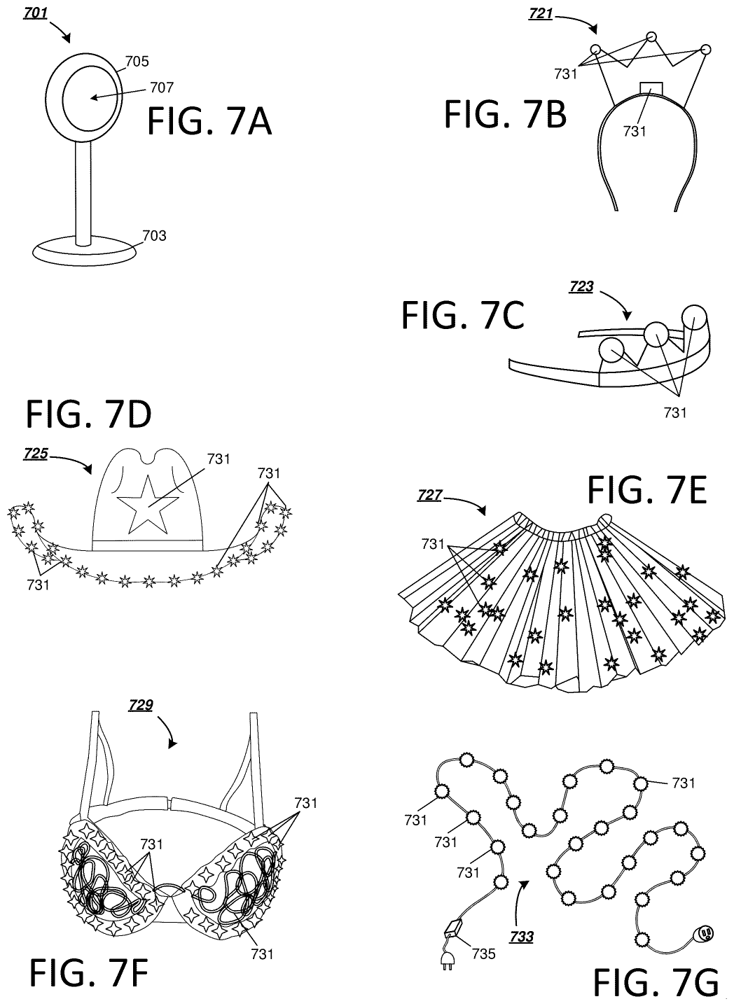

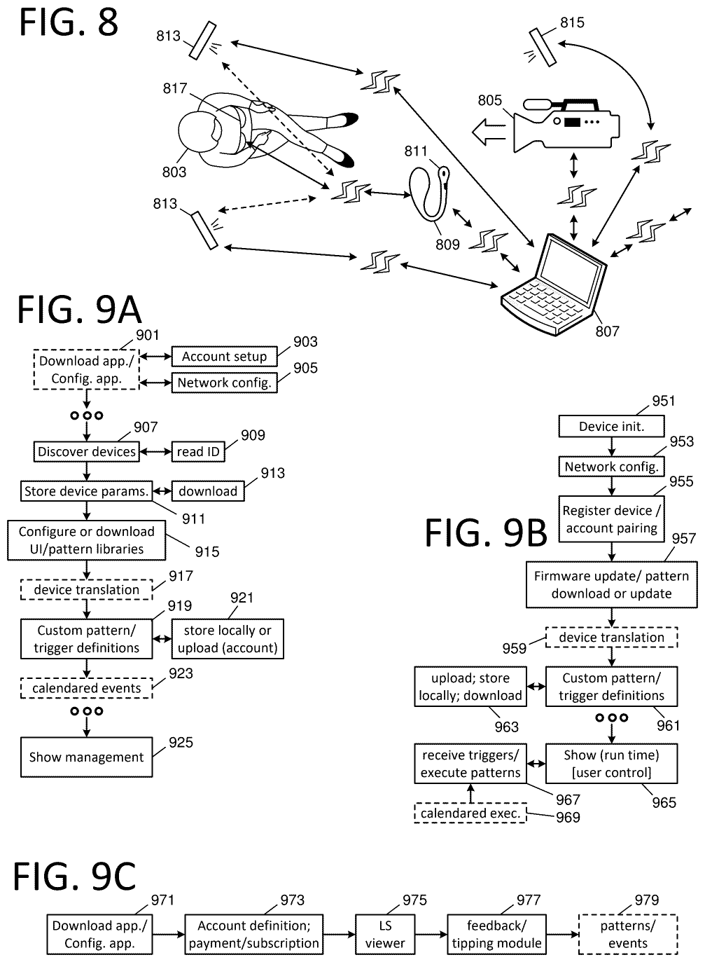

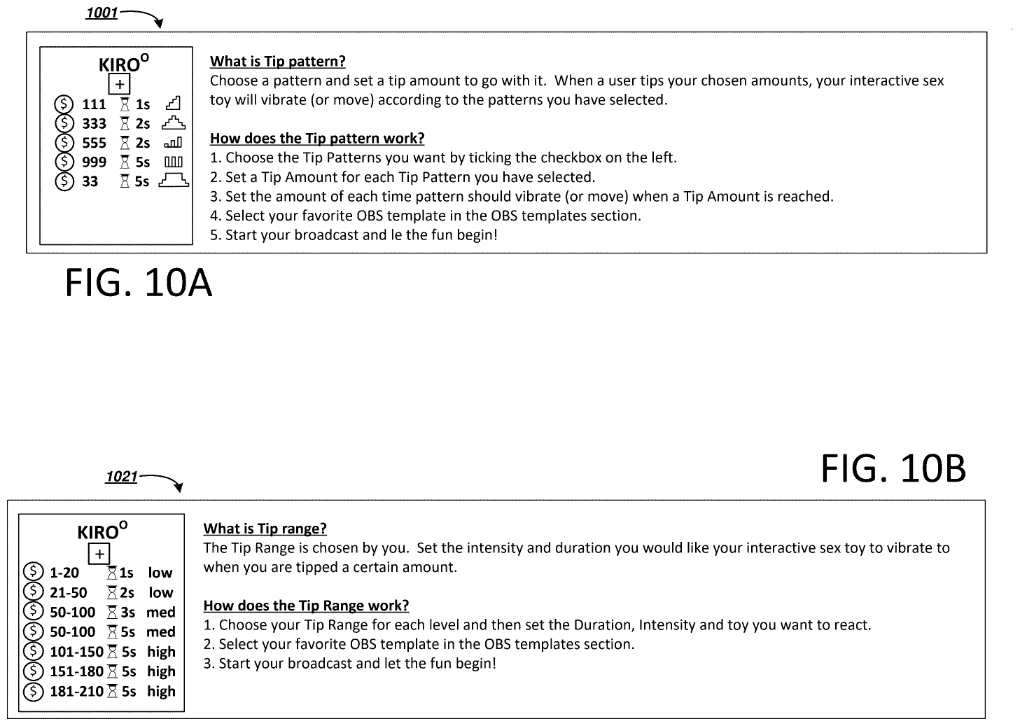

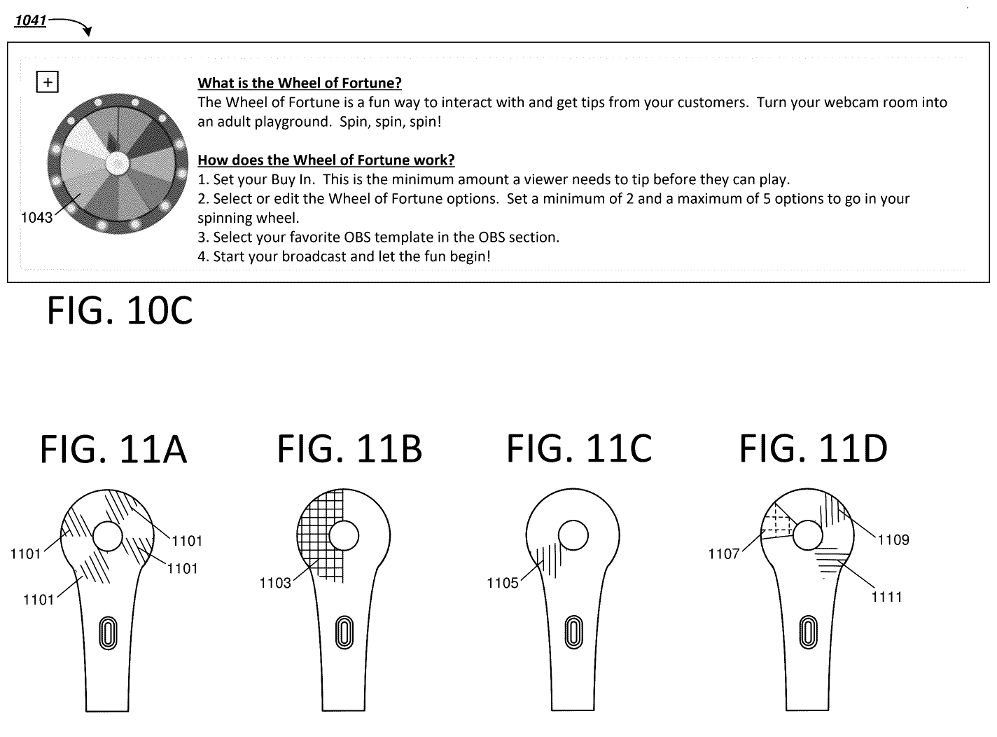

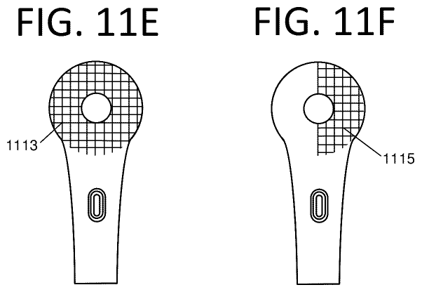

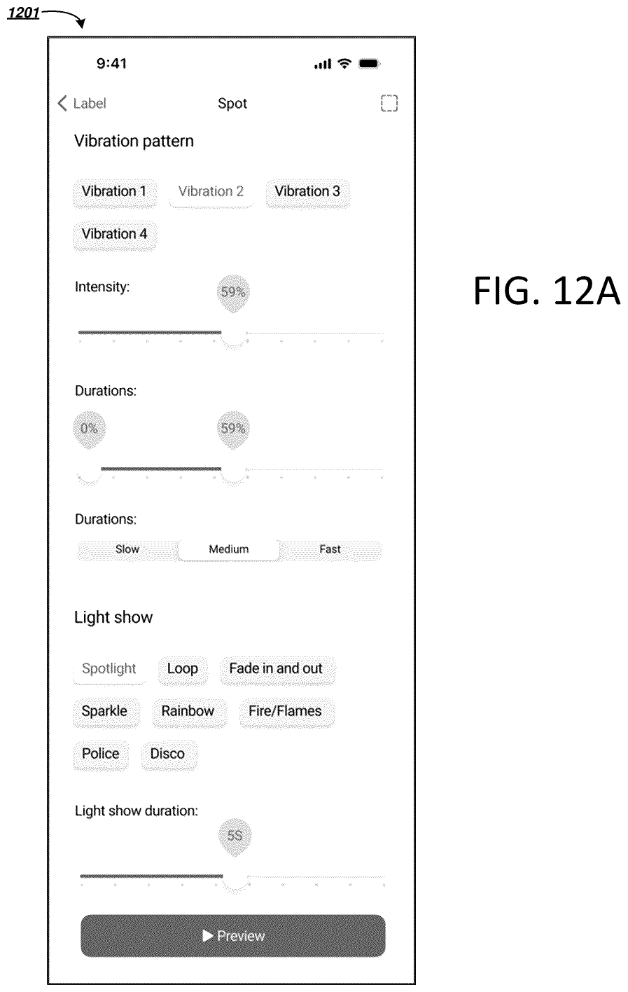

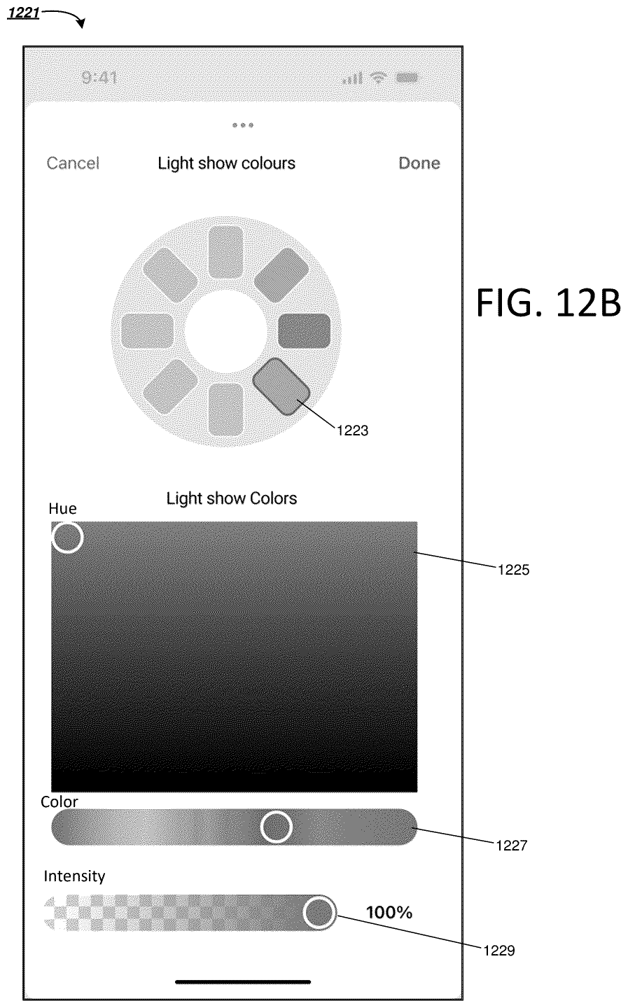

FIG. 5A shows a first embodiment of a clitoral stimulator 501. The stimulator 501 has a base portion, which vibrates (the base portion is behind the visible portion of the FIG., as indicated by numeral 503) and an exterior facing portion 505, which is shaded (hatched) so as to show its light emitting capability. The design of this device is similar to those described above, e.g., there are one or more motors (not shown), an on/off button 507, which can also be used for control functions, and the device is manufactured with a smooth silicone overlay, through which (occluded LEDs) emit light in a direction out of the drawing page (e.g., within the hatched region). Once again, a performer can use the stimulator 501 (device) as part of a live show, and a Bluetooth connection within the device receives event notification and/or trigger notification responsive to a detected event; in response, the device plays a light show through exterior facing portion 505. Once again, this capability can be used to enhance the level of excitement provided during a live show and to provide effective feedback/acknowledgement mechanisms to both performers and customers/viewers.

FIG. 5B shows another embodiment 521 of a clitoral stimulator, this time with a LED strip 523 which is configured to emit light outwardly (i.e., relative to the perspective of the drawing page). As before, each region or LED can be a multicolor LED device that is independently controllable according to the specifics of a preprogrammed pattern of a light show. [FIG. 5B once again also shows the presence of speaker holes, e.g., with an audio transducers (such as a speaker) optionally being used to play audio clips, music, beeps, sounds, or other preconfigured responses to trigger event signals.] As with other device embodiments, these patterns/responses can be programmed on a custom basis in some cases, as will be discussed in additional detail below. Once again, a Bluetooth or other wireless connection receives a pattern or trigger signal (e.g., for a pre-stored pattern) and the device once again responsively plays a show/sequence using its supported transducers (e.g., the LED strip and/or speaker and/or vibration pattern) in response to feedback or dynamically detected events.

FIG. 6A shows an example of a rabbit vibrator 601. The rabbit vibrator 501 has a first end 603, adapted for vaginal insertion, a nub 605, adapted for clitoral stimulation, and a handle end 607. The nub and the first end can be driven by a single motor or respective motors, as appropriate to the specific design. The rabbit vibrator also has a battery compartment 609, which houses replaceable batteries and which also mounts pertinent electronics, including a power/control button 611 and an LED light panel 613. As before, the LED light panel has an array of multicolor LEDs where each region or LED can be independently controlled as to power, color, intensity, frequency, phase, and so forth, to play the desired pattern associated with a light show. The motors likewise can optionally be controlled according to these patterns (e.g., each event can have a separate “track” for each transducer to be driven, for example, one for a first motor, one for a second motor, one for the LED display, or alternatively, for each LED, one for audio, video and so forth, with means for synching these tracks); clearly, there are different implementation options which are available to those having skill in electronics design and device design. The rabbit vibrator, as with embodiments before, has an internal Bluetooth or other wireless modem and antenna for receiving feedback, for controlling one or more of the transducers in response to detected events, and for synching with nearby devices.

FIG. 6B shows an example of a wand vibrator, 621. This vibrator has a first end 623 for clitoral stimulation and a second, base or handle end 625. A light display within the base 625 is actuated to play a light show responsive to detected events. Once again, this can be achieved using a ring arrangement of multicolor LEDs within the base, with the LEDs being arranged so as to direct a light show outward through a clear or transparent outer surface of the vibrator, in a manner that will be visible to performer and/or customer viewer; the capability of each LED to generate different light at different times as part of a light show or sequence is once again represented by distinctly hatched 627a-627e, as well as radiance icons (e.g., 629). This vibrator optionally has multiple motors, with the stimulation end being gimbal- or spring-mounted so to permit or induce different types of motion in three dimensions 631. A control dial 633 can be used to turn the device on and/off and for other control functions.

In the specific context of adult toys, for example, device configuration is not limited to the devices depicted above or even to vibrating devices, and can be implemented (by way of example) as wearable devices (e.g., strap on devices), male masturbation devices, nipple stimulators, and, indeed, as many other types of devices. The design of these and other, similar products is intended to be represented by FIGS. 2A and 2B, and by the other various FIGS. presented above.

As noted earlier, this disclosure also envisions performer devices which are not adult toys. FIGS. 7A-7G provide some nonlimiting examples of this, including some wearable devices and some accent devices (e.g., props).

FIG. 7A shows an example of a standing accessory 701 having a stand 703, which serves as a mount for an actuator portion 705; the actuator portion can house an illumination source, such that the device operates as a lamp (e.g., performance accent) in much the same manner as described above. For example, the stand portion can have an internal Bluetooth modem and antenna that can be paired with a performer's computing device (e.g., smart phone) or adult toy; when, and as a feedback event is detected (e.g., specific tipping threshold met), and it is desired to present a light show, that show can either be fully or partially played on the standing accessory. To cite a few implementation examples, one use-model can feature the standing accessory 701 playing the same or a different light pattern than, e.g., the tip of the vibrator of FIG. 3A. Alternatively, if a performer device such as a vibrator can play vibration patterns responsive to events but not present a light show, then the vibration pattern can be played on the vibrator in synchronicity with the light show being played on the standing accessory. Multiple standing accessories can be used together, each playing the same or a different “track” following event detection. The standing accessory 701 can also represent a different type of transducer, such as a standing loudspeaker; such an accessory can play audio in synchronicity with other patterns, for example, a light show being presented on an adult toy. In one contemplated embodiment, a service can permit customers/viewers to record audio, which is played on the accessory in tandem with event execution (e.g., presentation of a light show). Where the accessory is embodied as a lamp, a front portion 707 plays a light show, for example, by causing an LED display (mounted beneath a transparent or translucent front portion 707) to play a predetermined pattern or patterns; where the accessory is embodied as an audio speaker, the speaker can similarly be driven by Bluetooth connection to play a predetermined clip, music, or other audio sounds; when embodied as a display screen (e.g., touchscreen display), the front portion can similarly be used to display video or image content, to enhance a live show, as has been previously described. As with other device embodiments herein, in addition to having a Bluetooth connection, the accessory also has some means of identifying itself and its capabilities and for registering itself with a performer's network—in this manner, the device supports pairing with a software app. that can trigger the playing of customized patterns on the accessory, responsive to detected events. Similarly, as introduced earlier, in designs which feature multiple performer devices, including one acting as a “master” device, the accessory can connect to (or in some embodiments, serve as) that master device. In at least one contemplated version of the embodiment of FIG. 7A, the accessory has a power cord so as to be run off of a permanent power source.

FIGS. 7B-7F show a set of wearable devices, respectively, a crown 721, a tiara 723, a cowboy hat 725, a ballerina skirt 727, and a brazier 729. Each of these devices feature one or more light sources (e.g., LED displays) 731, a rechargeable or replaceable power source (e.g., a battery, not shown in these FIGS.) and a Bluetooth or other wireless modem and antenna). These devices can also, depending on embodiment, be paired to a performer's digital system (e.g., smart phone) or a master performer device, or be configured as Internet-ready and driven directly from a server. For example, once again using the non-limiting example of a gratuity threshold reached in connection with a live show, the crown, tiara, cowboy hat, skirt or brazier can be caused to play exciting light patterns, e.g., in synchronicity with a specific, intense vibration pattern, thereby enhancing appeal of the performance and serving as a means of confirming gratuity receipt of the performer and/or customer/viewer. Each of these depicted devices 721, 723, 725, 727 and 729 includes means for registering their presence (e.g., with a device type or ID code) and means for communicating with a computer, smart phone or other master device for purposes of responding to show or other streaming service feedback.

FIG. 7G shows a light string 733, e.g., in this case embodied as a set of “fairy lights,” which similarly can be used to enhance a live show. A control box 735 includes circuitry, such as a Bluetooth interface, which permits the light string to similarly receive triggers and/or light show patterns to be “played” on the light string. [It is noted that a similar circuitry is present in each of the embodiments of FIGS. 7A-7F, but is generally hidden from view as detracting from the aesthetics of the accessory.] In the case of FIG. 7G, the light string comprises a number of bright, high-voltage LEDs; it is of course also possible to use low voltage lights or some other means of illumination, e.g., with some type of power conversion means in the control box 735, or alternatively, to use a battery power supply. As should be apparent, the light string can be synched with other devices by a master (such as a performer's laptop, running a suitable software app). As with the other depicted accessories, the depicted light string can be used to play part of or all of a light show in association with a detected event, or to act as a backup (for example, playing the same light show as on another device but at a lower intensity), or playing background or secondary light effects. Many implementations can be designed by one have appropriate skill in show presentation.

FIG. 8 is an illustrative, plan view of a layout 801 representing an exemplary use-case. A performer 803 will provide streaming audio and/or video, which is captured via a camera and/or microphone 805. The camera and/or microphone 805 in this embodiment can be assumed to be a webcam that is controlled wirelessly by an app. on the performer's computer 807. For example, the user can be a performer who uses the app. on the computer to start and stop a live show. During the show, the app. on the computer, or a server at a central service location, monitors gratuity levels (or likes, or votes, or other forms of feedback) from a customer and/or viewer to detect occurrence of a predetermined event, defined by one or more associated thresholds. In one example, each event can be defined and/or customized by the performer, while in other cases, the events can be globally defined by a central service. If the show is an adult show, the performer may optionally use an adult toy, such as depicted by numeral 809. In the case of a vibrator, the toy is typically used by the performer as part of the narrative of the show, with control of the vibrator (e.g., movement and vibration) generally managed by the performer. When, however, the laptop (or server, depending on embodiment) detects that a gratuity threshold has been reached, it causes a transducer at the tail 811 (e.g., light source, motion source, audio source, image source) to play specified stimuli, generally a pattern. For example, if the toy is of the general type introduced by FIG., 3A, the event can trigger a light show as well as vibration patterns and sound patterns, as appropriate. In tandem (e.g., in synchronicity), the computer or server can also send one or more signals to accessory devices, graphically proxied in this FIG. by standalone accessories 813 and 815 and wearable clothing item 817. Each accessory can be controlled as desired in accordance with a defined pattern or other stimuli, e.g., a parallel “track” defined as part of the light show. Note that light displays from items 811, 813 and 817 are positioned so as to be captured by a camera (e.g., where the feed is a video feed), and thus, contribute directly to the content presented to the customer/viewer, whereas accessory 815 in this case is visible to the performer, and potentially illuminates the scene, but is not necessarily directly visible to the camera (and to the customers/viewers). In some embodiments, each device (e.g., toy, accessory, and so forth) possesses circuitry and/or other means for registering that device with a performer network and conversely, an app. at the perform side advantageously is designed to enroll/learn each device, drive patterns, and potentially permits custom pattern/event definition by the performer. As discussed previously, these described methods and capabilities can substantially add to the excitement and dynamic nature of live shows, for each of the performer and each customer/viewer.

FIGS. 9A-9C are block diagrams which show optional embodiments for instructional logic (1) for a performer network (e.g., installed on a performer's personal computer or smart device), (2) for a performer device that is to be paired with/matched to such a system, and (3) for download to a customer/viewer, respectively. These apps. can be provided independently of the sale of any device, and can be stored/maintained/provided or downloaded in the form of instructions stored on one or more physical storage media. Further, each depicted step/function described below should be viewed as optional and can, if desired, be implemented as a dedicated software module.

First, with respect to FIG. 9A, instructional logic can optionally be configured as a downloadable application 901, that is, with configuration information that will permit the app. to be installed on a digital system of the user/performer (such as a computer, smart phone, “smart” performer device, or other digital device) and configure itself to work on that system. As indicated by numerals 903 and 905, as part of that configuration, the app. can direct the performer to set up an account with, e.g., a service or platform that provides live performance feeds (audio or video, or both) to a remote partner or other customer/viewer, as well as to configure local wireless access for communication with performer devices (such as those described above with reference to FIGS. 2A-7G). In this latter regard, the app. uses function block 907 to discover local devices during some type of learning mode; the software causes the user's digital device to establish wireless (or wired) contact with discovered device(s) and to read an ID, 909 (which for example, can identify the device types, device serial number, manufacturer, and so forth). A set of interface parameters and capabilities are then downloaded, per numerals 911 and 913; in some embodiments, this can be directly from the discovered performer device while, in other embodiments, these things can be retrieved from a local database that is part of the app. or from a central library (e.g., element 181 from FIG. 1B). The app. then configures a local user interface (“UI”) for communication with each individual device, by identifying device capabilities and by configuring the performer's system to engage with/drive those capabilities, and otherwise interact with that device, per numeral 915. For example, if the particular user/performer device is a vibrator with a multicolor LED display capability but no audio capabilities, the app. can configure the UI to permit event customization and/or definition involving light patterns but not necessarily audio; alternatively, some implementations will permit a number of parallel “tracks” to be created to define event triggered patterns, and then simply not transmit created audio tracks. In still other embodiments, any tracks can be defined and transmitted/triggered, but are simply ignored by devices not having the pertinent capabilities or translated into some other form by those devices. In this latter regard, it is noted that some conventional adult toys feature some type of wireless communication capability, but that communications are generally not standardized, and associated functions vary from manufacturer-to-manufacturer; the app. can optionally implement a device translation library 917 to permit pattern definition locally, on the user's digital system dependent on device capabilities, with a sequence of commands to be sent to a ‘dumb’ performer device to change patterns, intensities, and so forth, so as to play a particular stimuli pattern. For example, if a given device from a given manufacturer provides for wireless selection of different, selectable vibration patterns, but cannot execute a light show, the app. can nevertheless provide for control over that ‘dumb’ device by translating a light show execution pattern into complementary commands to vary vibration patterns, with sequencing of light changes being translated into a series of wireless commands to iteratively change the vibration pattern. As referenced above, and per numeral 919, some embodiments also permit the performer to customize and/or define light shows (or other transducer patterns), for example, setting tip amounts and ranges and programming the effects, their sequence and timing, to be triggered on a dynamic basis based on customer/viewer feedback during a show. In some cases, events can be defined based on complex threshold combinations expressed in a Boolean or other equational format (e.g., a tip amount >$X USD from at least 3 different customers); many creative implementations will occur to those having ordinary skill in the art. The light show or other transducer patterns can be locally stored on the system (e.g., computer) or they can be stored centrally and downloaded. In other embodiments, these patterns can be defined on and/or stored directly on the performer device. In still other embodiments, a custom show or pattern can be uploaded to and stored at a central (e.g., server-accessible) location, for example, in association with the user's account, as referenced by numeral 921. As was referenced earlier (e.g., library 181 from FIG. 1B), a service or show platform can also optionally implement an event/pattern publication, rating and sharing, thereby further enhancing appeal of the live shows. FIG. 9A also shows an optional calendaring/sequencing system 923; this is to say, generally speaking, embodiments launch patterns when and as preprogrammed events are identified, but it is also possible to detect an event and then calendar execution of a corresponding light show or other stimuli for a future point in time, for example, in synchronicity with music “2 minutes later,” in synchronicity with actions of other performers or in synchronicity with some action at the customer/viewer end, and so forth; generally speaking, in such an implementation, the performer device typically receives a command to execute a particular stimulus pattern together with an appointment time or sequence indicator, which indicates when the stimulus pattern will be executed. Finally, while the functions described thus far in connection with this FIG. are typically offline functions (meaning that they can be performed in advance of a show), the app. also advantageously includes code for live show management, for example, permitting a performer to launch and end shows, view tips and customer feedback, and so forth, as referenced by numeral 925.

Note that while the app. of FIG. 9A has been described as something that can be downloaded to and installed on a performer's system (e.g., smart device), it is also contemplated that some performer devices will arrive with firmware preloaded, where that firmware also generally corresponds to this FIG., e.g., such that that logic does not need to be downloaded. For example, the device of FIG. 3C can be bundled with firmware that generally performs the functions of FIG. 9A, permitting slave discovery and pairing and providing for custom pattern/event/trigger definition.

FIG. 9B is a block diagram of one embodiment of software on a performer device (e.g., a device from FIGS. 2A-7G) that is to be paired with some type of master, e.g., a laptop computer on a performer network. On first-power-on, the device launches an initialization routine, for example, permitting language selection (e.g., where a LCD touchscreen is present), to identify a user/performer wireless network, Bluetooth pairing, and so forth, per numerals 951 and 953. As part of this process, the device is registered with the performer's system, 955, such that its capabilities may be registered and such that it may later be driven in connection in response to detected events; for example, the device can optionally establish a handshake with a user's/performer's system (e.g., laptop, smart phone, “master” device, and so forth), such that the system “knows” that the specific device is present and is available for use in a show. In conjunction with this process, it is contemplated that some devices will employ firmware that needs to be updated from time-to-time, and this can be effectuated as part of function block 957 through the performer system, once paired (e.g., the instructional logic from FIG. 9A can be designed to provide for device firmware version identification and update). Some device designs, as mentioned, will also permit local pattern storage (e.g., for launching in response to a dynamic trigger signal). As referenced by function block 959, it is also possible for devices to implement a translation analogy to block 917 from FIG. 9A, if a foreign (e.g., third party) technology is designed so as to provide for a light show, and the device in question is not capable of presenting such a show, the device can be designed to provide its own translation protocol (e.g., so as to recognize commands for a light show and instead transduce these signals as intense vibrator patterns). Some devices also are designed to permit local event/trigger/threshold customization and/or definition, for example, by permitting the performer to directly input into the device parameters such as intensity levels, color selection, frequency levels, and so forth (e.g., via touchscreen selection), or to select and download light shows or other event stimuli, per numerals 961 and 963. The device instructional logic in this embodiment can provide for direct run time control over the device by the performer, e.g., managing functions such as vibrator frequency, turning on lights or LED patterns, and so forth, per numeral 965. During run time, this logic also receives and manages event execution signals, and responsively controls the device's various transducers, optionally in accordance with locally varied parameters such as intensity. As indicated earlier, and as referenced by dashed-line block 969, some embodiments permit the advance calendaring of patterns that are responsive to customer/viewer feedback; to this end, these embodiments permit receipt of appointment or sequence information and they also provide some means (e.g., a local clock/timing system) for timing synchronization/sequencing.

FIG. 9C shows a block diagram for an optional customer/viewer app. As indicated by function blocks 971, 973, 975 and 977, such an app. provides for a dedicated platform for viewing live shows and for directly providing feedback. For example, the app. can be configured for download (e.g., from an app store or central server) and for installation on a computer, smart phone or other digital system of the customer/viewer. Once installed, this app. can provide an interface for the customer/viewer to establish an account, and pre-enter payment information (such as providing a credit card number), or purchase advance “tip credits.” The app. also provides a dedicated viewing platform for viewing live shows (live show viewer, 975), and an embedded tipping/feedback module 977. In this manner, a customer/viewer can be provided with a secure platform for viewing live shows without need to continually reenter payment information and without creating delays which might interfere with the customer's/viewer's attention during a live show. Notably, it is contemplated that these functions can also be combined with some or all of the functions of FIG. 9A (e.g., the system can be designed to provide a single app. for direct private party streaming and feedback between two parties, for example, with either one of two participants streaming video and the other providing feedback in association with two-way interplay). Finally, such an app. can optionally also be provided with capabilities (e.g., a module) for customer event/“light show” definition, i.e., permitting a customer/viewer to design their own stimuli patterns and trigger a consequent light show, clip, sound or other action directly on one or more performer devices; in one contemplated embodiment, this function permits the customer/viewer to add or to launch their own sound, image, vibration patterns, light shows, and/or video clips and have them “played” directly on the performer device (e.g., on the device of FIG. 3C), as soon as payment is authenticated.

While FIG. 9C shows general layout for a customer/viewer app., note that these functions can also be implemented in the form of software that is not downloaded; for example, it can be implemented on a service bureau basis and hosted directly on a website, with various functions provided through a conventional browser, with associated web flow functionality.

FIGS. 10A-12B are used to present example UIs which are pertinent to event and response stimulus programming and customization.

FIG. 10A shows a screenshot 1001 of UI for defining a tip pattern as a function of minimum tip threshold. Items seen within a box at the left side of the screenshot (e.g., “$111”) are individually selectable for editing or deletion, and an “add” button (marked by a “+” symbol) is provided to create new tipping or other events. The UI advantageously features an assortment of predefined tipping events which can each be selected for customization/editing, such as those events illustrated in the FIG. For example, the first depicted row shows a hypothetical tip amount of “$111” (one hundred eleven US dollars), a pattern length of 1 second (“1 s”) and a stepwise-increasing stimulus pattern; applied in association with the device of FIG. 3A, if a tip of at least $111 USD but less than $333 USD was received, the system would proceed to responsively trigger a corresponding vibration pattern. In a dialog for each tipping event, a user can also select a light show pattern and customize that pattern, for example, as exemplified by FIGS. 10C and 12A-12B. Naturally, this example represents a relatively straightforward implementation but, as noted earlier, other embodiments can permit definition of complex patterns, involving motion, images, audio and video and other things. The UI of FIG. 10 permits, in one embodiment, the performer or particular streaming service to also customize tip levels.

FIG. 10B shows another screenshot 1021 of a UI which permits associating tip ranges (e.g., groups of tipping events) with durations and intensity levels. Items depicted within the box at the left side of the screen are once again individually-selectable for editing or deletion, and a “+” button is again provided to permit a user to custom-define their own patterns from scratch. “Intensity” in this context can have a number of different meanings depending on performer device and its capabilities, e.g., it can refer to amplitude, frequency, volume, brightness, color, or anyone of a number of parameters that can be detected by human senses; in the example specifically depicted, the pattern selected is to be “played” on a vibrator in the form of motion of a corresponding intensity and duration, if and when payment of a gratuity is detected within the corresponding range.

FIG. 10C shows yet another screenshot 1041, this time illustrating a “wheel of fortune” function. In this regard, the performer can link each tip to a light show or other set of “tracks” to be triggered by a feedback event. The performer can then edit a response (stimulus, e.g., light show) pattern for each “pie slice” appearing on the wheel. When a customer/viewer selects this function and provides a corresponding gratuity, a color wheel appears on the customer's/viewer's screen and a complementary wheel of fortune is “played” (i.e., spun) on the performer device, as a light show. If the performer device does not support a light show, but features other types of transducers, another type of stimulus can be defined. The performer can define tipping required for this function, as well as the stimulus impact of each “pie slice” depicted on the wheel. For the pie slice in the FIG. numbered 1043, for example, the performer can link a stimulus (e.g., vibration pattern, light show, or other action) to be “played” on the vibrator of FIG. 3A to the matching wheel position, including for example a vibration intensity and vibration pattern to be driven by the vibrator, as well as a specific light show to be played on the performer device. As the wheel spins on the viewer's/customer's screen, the ring-shaped LED display on the “tail” of the device of FIGS. 3A-3B is also controlled so as to simulate the same spinning wheel. Note that while FIG. 10C is seen has having different grayscales for different “pie slices,” e.g., 1043, in one embodiment, these can be different colors; similarly, while this display is matched to the LED display for the device form FIG. 3A, there are analogies for other types of performer devices, for example, having transducer capabilities matched to a customization UI (such as depicted in FIG. 10C).

FIGS. 11A-F are similar in nature to FIG. 3B, but use cross-hatching to represent different illuminated portions of a LED display on the “tail” section of FIG. 3B. These FIGS. are used to narrate the “spinning wheel of fortune” example just given. In this regard, FIG. 11A shows a first color (represented by diagonally-slanted hatch lines), where the color is displayed as four “pie slices” 1101, i.e., forming the general shape of a cross in the FIG. By contrast, FIG. 11B shows a second color (represented by vertical and horizontal cross-hatching), displayed on a left side 1103 of the ring-shaped display; FIG. 11C shows a third color (i.e., purely vertical hatch lines), 1105, which can represent, for example, the pie slice 1043 from FIG. 10C (e.g., illuminated as the wheel spins, or to denote its stopping position). FIG. 11D shows the simultaneous presentation of three different colors in three different pie slices, 1107, 1109 and 1011, e.g., which can be used to represent a time-sequenced spinning motion or some other pattern on the display. FIG. 11E shows all portions of the ring LED display fully illuminated 1113 (once again, with the second color from FIG. 11B), while FIG. 11F is similar to FIG. 11B, but this time shows the “right-half” of the ring LEG display, 1115, lit once again with the second color. These examples variously indicate how a UI can be manipulated to create a sensory pattern to be transduced on a given performer device; one of ordinary skill in the art can implement with analogies, for example, for performer devices which include motors, speakers, displays, and so forth.

FIG. 12A shows a screen shot 1201 of a UI associated with customizing light and vibration patterns for a performer device, specifically, for the device from FIGS. 3A-3B. As indicated by the FIG. the performer can create a new pattern or edit an existing pattern, and can select among predefined vibration patterns (e.g., “vibration 1,” “vibration 2,” “vibration 3,” and “vibration 4”), intensity level (e.g., depicted at 59% of maximum), duration of each pattern cycle (e.g., also depicted as 59% of maximum), and pattern speed (e.g., “slow,” “medium” or “fast”). With respect to light patterns (i.e., the “light show”) to be displayed on the device, in this example, the user/performer is given a choice of 8 predefined patterns and is provided an ability to set duration (selected to be “5 seconds” in the FIG. using a slider bar). For example, a “spotlight” pattern can be configured to turn all LEDs on to bright white, while a “loop” patterns cycles through different colors and intensities. Similarly, other depicted, predefined patterns in include “fade in and out,” “sparkle,” “rainbow,” “fire/flames,” “police” and “disco.” While this example provides a UI tailored to the example device of FIGS. 3A-3B, it should be appreciated that many different possibilities exist, including UIs geared towards permitting performers or others to custom-build and name their own patterns, and to control devices/stimuli other than just vibration and light.

FIG. 12B shows a screen shot 1221 of a UI that facilitates building a custom pattern, e.g., for the device from FIGS. 3A-3B. In this case, for example, a top portion of the FIG. shows a LED ring (i.e., corresponding to the LED positions from FIG. 3B). Manipulation of this graphic permits a user define a sequence and, for each LED seen in FIG. 3B (having a corresponding position in the LED ring depicted in FIG. 12B, e.g., at position 1223), and for each display step in the sequence, the user can define custom color scheme (e.g., by selecting hue 1225, color 1227 and intensity 1229 at corresponding portions of the UI). The performer can build patterns of light selection, with these then being triggered (i.e., “played”) on the matching, ring-shaped LED display as the corresponding feedback event is detected during a live show.

Once again, it is noted that FIGS. 12A-12B show a UI tailored to a specific product or manufacturer, i.e., having specific capabilities such as “vibration” and “light;” extensions of these examples are contemplated for other types of motion and for other types of displays/presentations, for example, for types of motion such as vibration, expansion, constriction, flex, torsion, extension, contraction, light, sound, images, video sequences, and many other types of things. It is also possible to define a generic interface usable across devices, device platforms and manufacturers, e.g., as indicated earlier. Accordingly, the examples provided by the FIGS. above should be viewed as illustrative and not limiting, and it should be understood that many different types of embodiments are contemplated.

There are also many different forms in which the inventive principles herein can be embodied. To recap, firstly, a service, method or platform/machine can be adapted to stream a live performance, as discussed earlier. This disclosure contemplates different implementations of these principles, e.g., a central and/or networked component that provides/manages the service, as seen in FIGS. 1A-C, a performer network and/or associated components such as a performer device, or as instructional logic, for example, code downloadable to or useable on a performer's computer or device, code downloadable to and executable on a server or streaming source, and cod downloadable to or executable on a performer device. Other implementations also exist.

It is also contemplated that the described techniques can be implemented as a system or set of components for use by a set of private individuals. For example, as alluded to previously, the various described devices, systems, software, platforms and so forth can be implemented in a manner not involving any type of commercial service; for example, one party can stream audio or video to a second, while the second can provide feedback in some forth, where that feedback is monitored to detect specific events associated with some type of threshold, and used to take some type of preconfigured action. Clearly many possibilities exist and are contemplated by this disclosure.

Various modifications and changes may be made to the embodiments presented herein without departing from the broader spirit and scope of the disclosure. Features or aspects of any of the embodiments may be applied, at least where practicable, in combination and/or permutation with any other of the embodiments or in place of counterpart features or aspects thereof, and each is to similarly be considered “optional” as to any embodiment and/or combination/permutation. Accordingly, the features of the various embodiments are not intended to be exclusive relative to one another, and the specification and drawings are to be regarded in an illustrative rather than a restrictive sense.

We claim:

1. An apparatus comprising:
a body having a surface that is be applied in contact with a portion of the human body, to stimulate the portion of the human body;
a plurality of light sources;
a network interface, the network interface operable to receive at least one signal corresponding to a light pattern that is to be displayed by the apparatus, while the surface is providing stimulation to the portion of the human body, in response to a dynamically detected event; and
circuitry operable to control the plurality of light sources to display the light pattern in response to receipt of the at least one signal.

2. The apparatus of claim 1 wherein the apparatus is embodied as a sex toy, and wherein the apparatus further comprises a motor that is configured to be actuated, during operation of the apparatus, to cause the surface to vibrate, move or deflect.

3. The apparatus of claim 2 wherein the circuitry is also operable to control operation of the motor in response to the at least one signal, such that both of the plurality of light sources and the motor are actuated in a manner dependent on the at least one signal.

4. The apparatus of claim 3 wherein the sex toy is a vibrator having a first end or side and a second end or side, wherein the surface is born by the first end or side, the first end or side being adapted for vaginal or clitoral stimulation, and wherein the second end or side mounts the plurality of light sources.

5. The apparatus of claim 4 wherein:
the apparatus further comprises memory to store a user-defined intensity setting; and
the circuitry is operable to vary at least one of the light pattern or the vibration, movement or deflection in dependence on each of the user-defined intensity setting and the at least one signal.

6. The apparatus of claim 2 wherein the apparatus further a user interface, wherein the user interface comprises an electronic display screen, wherein the circuitry is operable to receive at least one setting entered via the user interface in a manner dependent on operation of the electronic display screen, and wherein the circuitry is operable to control at least one of the motor or the plurality of light sources in dependence on both of the setting and the at least one signal.

7. The apparatus of claim 6, embodied as a vibrator.

8. The apparatus of claim 1 wherein the apparatus further an electronic display screen, and wherein the circuitry is operable to control the electronic display screen so as to display at least one image in response to the at least one signal.

9. The apparatus of claim 8 wherein the plurality of light sources comprise portions of the electronic display screen.

10. The apparatus of claim 1 wherein each of the light sources comprises a multicolor light emitting diode (LED) device.

11. A method comprising:
providing access, by at least one viewer, to live audio or video content, wherein the live audio or video content comprises activity of a human performer;
electronically receiving feedback, from the at least one viewer based on the live audio or video content, and comparing a metric based on the feedback to at least one predetermined threshold;
detecting an event when the comparison indicates that the metric satisfies the at least one predetermined threshold; and
responsive to detection of the event, and contemporaneous with capture of the live audio or video content, sending to the human performer, via an electronic communication network, at least one electronic control signal, the at least one electronic control signal adapted to cause automated presentation of a sensory stimulus by a device associated with the performer, wherein the sensory stimulus is perceptible, while the human performer performs the activity, by at least one of the human performer or the at least one viewer.

12. The method of claim 11 wherein the live audio or video content comprises video content and wherein the device comprises at least one of an article of clothing or a stimulus device used by the human performer contemporaneous with the live audio or video content.

13. The method of claim 11 wherein the device comprises an adult toy and wherein the at least one electronic control signal is to control at least one actuator of the adult toy.

14. The method of claim 13 wherein the adult toy comprises a vibrator.

15. The method of claim 13 wherein the at least one actuator comprises a light source.

16. The method of claim 11 wherein the feedback comprises at least one gratuity, wherein the at least one predetermined threshold defines a minimum gratuity condition, wherein the method further comprises confirming a payment associated with the minimum gratuity, and wherein sending the at least one electronic control signal is performed dependent on successful confirmation of the payment.

17. The method of claim 11 wherein the live audio or video content comprises live video, wherein the method further comprises operating at least one web server, and wherein providing the access is performed by enabling web access to the live video.

18. The method of claim 11 wherein the live audio or video content comprises live video, wherein the method further comprises providing a software application for download to the at least one viewer, the software application adapted for installation on a digital device associated with the least one viewer, wherein the software application is configured to verify payment of at least one gratuity made by the at least one viewer, using the digital device, and wherein receiving the feedback comprises receiving the feedback from the software application post-installation on the digital device.

19. The method of claim 18 wherein the software application is configured to control a dedicated player for the live audio or video content, and wherein providing access comprises causing the software application to play the live audio or video content on the player post-installation on the digital device.

20. The method of claim 11 wherein the sensory stimulus comprises a predetermined sequence of stimuli and wherein sending the at least one control signal comprises transmitting one or more commands which are adapted to automatically cause presentation of the predetermined sequence of stimuli, by the device, in a manner captured by the live audio or video.
